(19) United States
(12) Patent Application Publication
(10) Pub. No.: US 2004/0190242 A1
(43) Pub. Date: Sep. 30, 2004

(54) Computer radiation module

(76) Inventor: Kuang-Yao Lee, Taipei (TW)

Correspondence Address: BIRCH STEWART KOLASCH & BIRCH, PO BOX 747, FALLS CHURCH, VA, 22040-0747, US

(21) Appl. No.: 10/394,156

(22) Filed: Mar. 24, 2003

(51) Int. Cl. G06F 1/20

(52) U.S. Cl. 361/687

(57) ABSTRACT

A computer radiation module located between a central processor and a power supply includes a first radiation plate, a second radiation plate and a transfer member connecting to the first radiation plate and the second radiation plate. The first radiation plate and the transfer member transfer heat generated by the central processor to an air fan, and the second radiation plate transfers heat generated by the power supply to the air fan. Thus the heat generated by the central processor and the power supply are gathered and discharged effectively.

### FIELD OF THE INVENTION

The present invention relates to a computer radiation module and particularly to a radiation module that has radiation plates, a transfer member and an air fan to effectively discharge heat from the central processor and the power supply.

### BACKGROUND OF THE INVENTION

In computer systems the elements that generate most heat are the central processor, hard disk drives, north bridge chipset (North Bridge) on the main board and display chip on the display interface card. These elements are installed inside the computer casing. On the devices that have a higher temperature, vendors usually install a radiation plate on the heat generating source to facilitate heat dissipation. Some even adding an air fan mating the size of the radiation plate on the radiation plate to generate airflow to discharge heat rapidly from the radiation plate to lower the temperature of the chips. However, such an approach can only dispel the heat from the heat sources to enable the heat generating chips to operate within the allowable temperature limit. The heat generated by the elements is still trapped inside the casing without being really discharged outside the casing. While the power supply located in the casing has a 8×8 cm air fan to disperse the heat generated by the elements in the casing, and the casing generally has heat dissipation openings to facilitate heat discharge, the effect is generally not very satisfactory. As the air fan on the power supply and the heat dissipation openings of the casing cannot achieve “air convection” effect, the temperature inside the casing gradually becomes higher when computer operation time increases.

In short, the conventional heat dissipation structures have the following drawbacks pending to be resolved:

1. The radiation fins and air fan located respectively on each element tend to squeeze the interior space of the host casing and hinder heat dissipation.

2. The host casing has a plurality of air fans installed in the interior. Air turbulence is prone to occur and results in heat circulation inside the host casing.

3. Air fan operation consumes energy and becomes a burden to the power supply. As a result, not only additional heat is generated, operation performance also is affected.

### SUMMARY OF THE INVENTION

Therefore the primary object of the invention is to resolve the aforesaid disadvantages. The invention aims at integrating heat generated by various radiation plates and discharging the heat through a single air fan.

In order to achieve the foregoing object, the computer radiation module of the invention is located between the central processor and the power supply. The radiation module includes a first radiation plate, a second radiation plate and a transfer member connecting the first and the second radiation plates. The first radiation plate and the transfer member transfer heat of the central processor to the air fan. The second radiation plate also transfers heat of the power supply to the air fan. Thereby the heat generated by the central processor and the power supply is discharged effectively.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is a cross section of the rear side of the invention.

FIG. 4 is a schematic view of the invention showing the heat flow direction.

### DETAILED DESCRIPTION OF THE PREFERRED EMBODIMENT

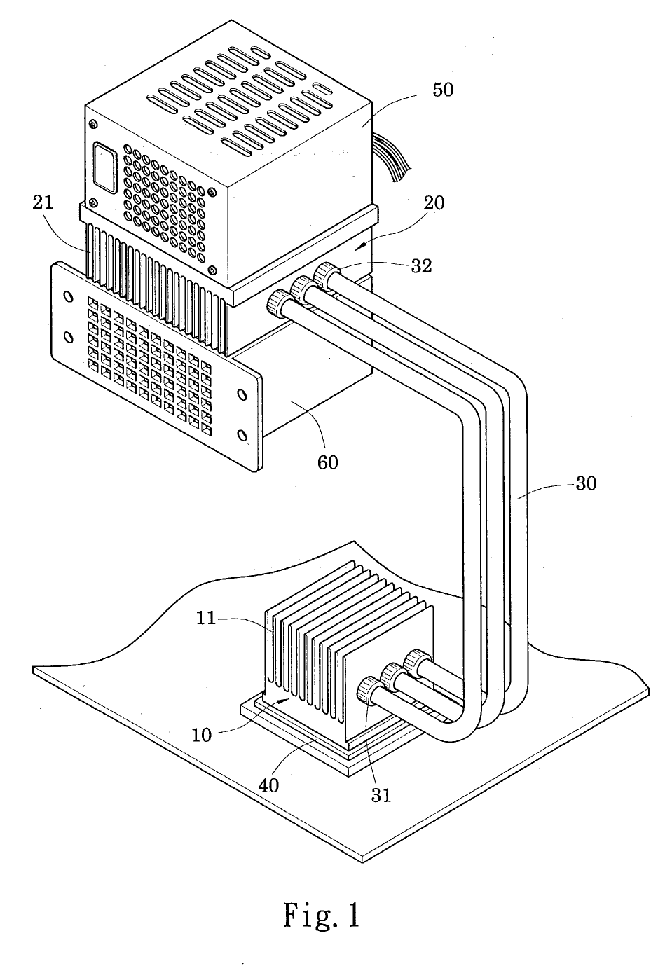

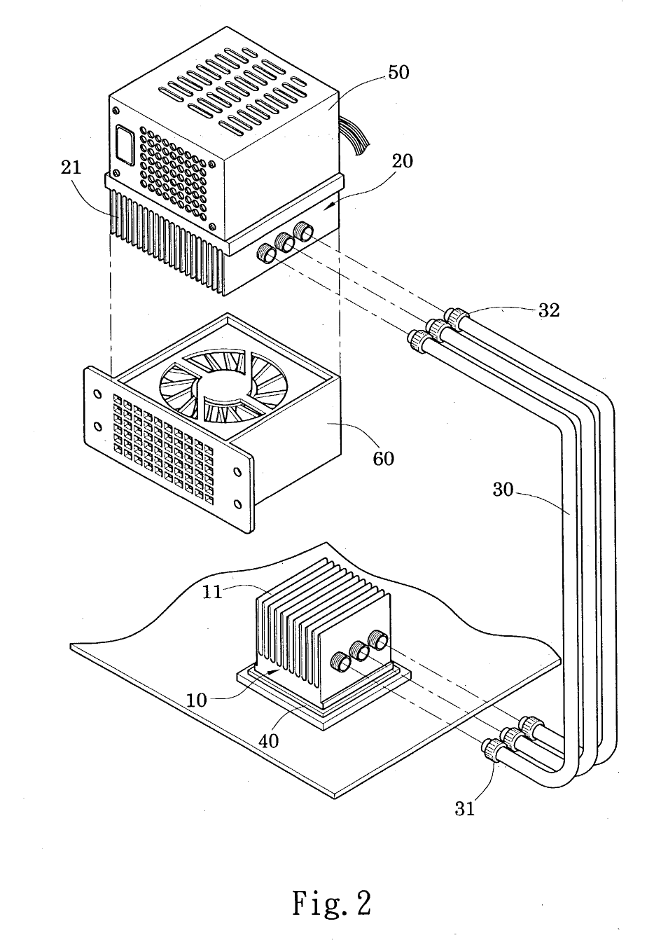

Referring to FIGS. 1 and 2, the computer radiation module of the invention is located between a central processor 40 and a power supply 50. The radiation module consists of a first radiation plate 10 mounted onto the central processor 40, a second radiation plate 20 mounted on the power supply 50 and a transfer member 30 connecting the first radiation plate 10 and the second radiation plate 20. The first and the second radiation plates 10 and 20 have respectively parallel metal fins 11 and 21 to increase the area to facilitate heat dissipation. The transfer member 30 consists of metal heat transfer tubes for gathering heat absorbed by the first and the second radiation plates 10 and 20. A high speed radial air fan 60 is provided to dispel the heat being gathered. The first and the second radiation plates 10 and 20 have respectively an anchor section 12 and 22 corresponding to different selections of the transfer member 30 to mate the elevation difference of the central processor 40 and the power supply 50.

For assembly, first, fixedly mount the first radiation plate 10 onto the central processor 40 and the second radiation plate 20 onto the power supply 50; next, fasten another side of the second radiation plate 20 to the air fan 60; then select a suitable transfer member 30 according to the interval and elevation difference of the power supply 50 and the central processor 40. As the first and the second radiation plates 10 and 20 have respectively the anchor section 12 and 22, and the transfer member 30 has fastening sections 31 and 32 corresponding to the anchor sections 12 and 22, the transfer member 30 may be fastened to the first and the second radiation plates 10 and 20 for collecting and gathering heat generated by the central processor 40 and the power supply 50.

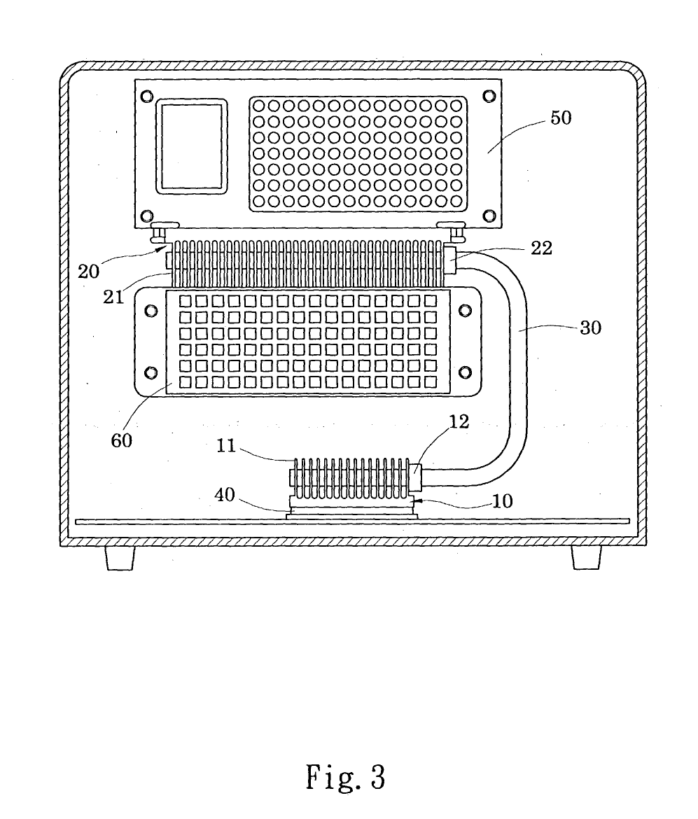

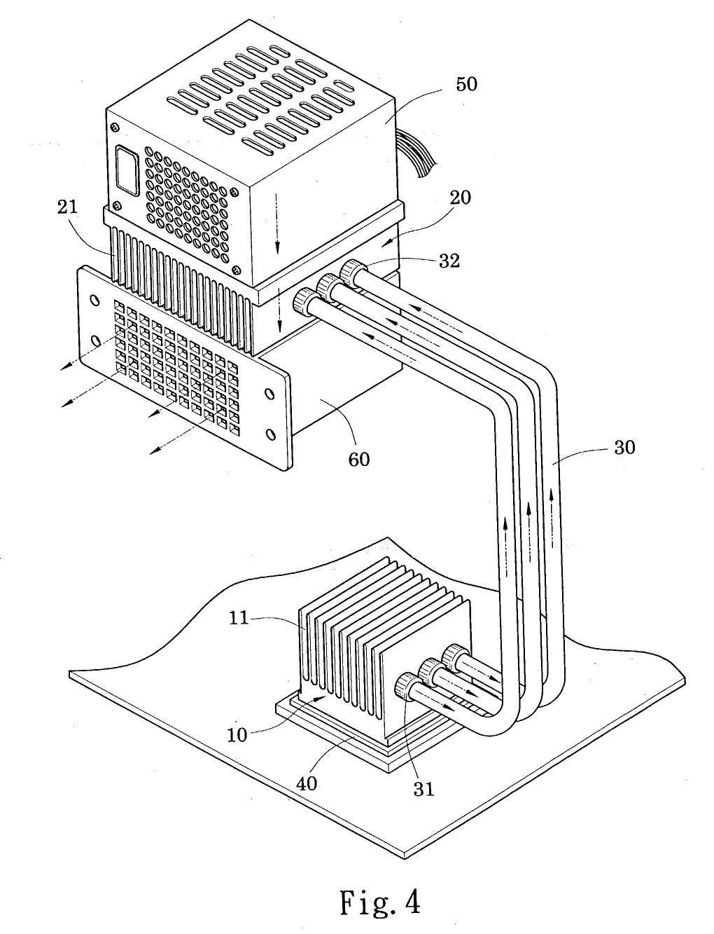

Referring to FIGS. 3 and 4, when in use, heat generated by the central processor 40 is initially dispersed to the first radiation plate 10 which has a greater area to partially reduce the temperature. The rest heat is transferred to the second radiation plate 20 through the transfer member 30. Heat generated by the power supply 50 is transferred downwards to the second radiation plate 20 which disperses a portion of the heat. Remaining heat and the heat transferred from the first radiation plate 10 are combined and transferred to the air fan 60 located below the second radiation plate 20. Then the high speed radial air fan 60 dispels the gathered heat.

In summary, the invention has the following main features:

1. The invention employs the first radiation plate 10, second radiation plate 20 and transfer member 30 to integrate heat generated by the central processor 40 and the power supply 50, then discharges the heat through a single air fan 60.

2. The invention needs only one set of air fan 60 to discharge the heat generated by the highest temperature portions of the computer system (central processor 40 and power supply 50). The interior space configuration of the host may be greatly simplified. Interference and turbulence between the air fans that might otherwise occur may also be avoided.

3. Installation and configuration of the first and the second radiation plates 10 and 20 may be adjusted through the transfer member 30 without the need of replacing the entire radiation module for different machine types.

What is claimed is:

1. A computer radiation module located between a central processor and a power supply, comprising:
a first radiation plate mounted onto the central processor;
a second radiation plate mounted onto the power supply being connected to an air fan; and
a transfer member connecting to the first radiation plate and the second radiation plate;
wherein the first radiation plate and the transfer member transfer heat generated by the central processor to the air fan, and the second radiation plate transfers heat generated by the power supply to the air fan.

2. The computer radiation module of claim 1, wherein the transfer member runs through the first radiation plate and the second radiation plate.

3. The computer radiation module of claim 1, wherein the first radiation plate and the second radiation plate have respectively an anchor section.

4. The computer radiation module of claim 3, wherein the transfer member has fastening sections corresponding to the anchor sections.

5. The computer radiation module of claim 1, wherein the transfer member is a heat transfer tube.

6. The computer radiation module of claim 1, wherein the radiation plates have parallel fins.

7. The computer radiation module of claim 1, wherein the air fan is a high speed radial fan.
